(19) United States
(12) Patent Application Publication
(10) Pub. No.: US 2007/0155268 A1
(43) Pub. Date: Jul. 5, 2007

(54) Polishing pad and method for manufacturing the polishing pad

(75) Inventors: Chung-Ching Feng, Sanmin (TW); Chen-Hsiang Chao, Zuoying (TW); I-Peng Yao, Sanmin (TW); Yung-Chang Hung, Sanmin (TW); Jyh-Jen Lee, Nanzi (TW)

Correspondence Address: NIKOLAI & MERSEREAU, P.A., 900 SECOND AVENUE SOUTH, SUITE 820, MINNEAPOLIS, MN, 55402, US

(73) Assignee: SAN FANG CHEMICAL INDUSTRY CO., LTD., Jenwu Shiang (TW)

(21) Appl. No.: 11/323,651

(22) Filed: Dec. 30, 2005

(51) Int. Cl. B32B 27/04

(52) U.S. Cl. 442/103; 442/109; 442/148; 442/164; 442/168; 156/148

(57) ABSTRACT

A polishing pad includes a non-woven cloth and a continuous porous polymer. The non-woven cloth includes fibers. The polymer includes a plurality of holes communicated with one another. The polymer is cured in and bonded to the non-woven cloth. A surface of the polishing pad is constituted by the fibers of the non-woven cloth and the polymer.

### BACKGROUND OF INVENTION

1. Field of Invention

The present invention relates to a polishing pad and a method for manufacturing the polishing pad.

2. Related Prior Art

Chemical mechanical polishing (“CMP”) processes are used in semi-conductors and liquid crystal display industries in order to manufacture the surfaces of semi-conductor substrates and glass substrates planar.

In U.S. Pat. No. 6,860,802, “Polishing pads for chemical mechanical planarization”, for example, a thermosetting mixture is poured into a cylindrical mold with grooves. Then, the thermosetting mixture is cured and become a block. The block is cut into films. Each of the films is polished and becomes a polishing pad. However, as the density of the thermosetting plastic varies at different points in the mold, and as the temperature varies at different points in the mold, the resultant polishing pads includes holes that are different from one another in size and unevenly positioned. After the polishing and cutting process, the difference in the sizes of the holes gets more obvious. Moreover, the holes are often not communicated with one another so that slurry cannot flow smoothly and that polishing particles contained in the slurry cannot be distributed effectively. Furthermore, debris cannot be expelled from a workpiece that is being polished so that the debris stays on and scratches the workpiece. In addition, as the polishing pads are made in batches, the polishing pads vary considerably from batch to batch. Thus, it is very difficult to control the polishing effects using the polishing pads made in this conventional process.

The present invention is therefore intended to obviate or at least alleviate the problems encountered in prior art.

### SUMMARY OF INVENTION

According to the present invention, a polishing pad is provided. The polishing pad includes a non-woven cloth and a continuous porous polymer. The non-woven cloth includes a plurality of fibers. The continuous porous polymer is provided over and between the fibers of the non-woven cloth and includes a plurality of holes defined therein. On a surface of the polishing pad, some of the fibers of the non-woven cloth are exposed from the polymer.

According to the present invention, a method is provided for manufacturing a polishing pad. The method includes the step of providing a non-woven cloth with a plurality of fibers, the step of providing a semi-product of the polishing pad by submerging the non-woven cloth in a polymer resin and curing, washing and drying the polymer resin, and the step of providing a final product of the polishing pad by finishing the semi-product of the polishing pad. On a surface of the polishing pad, some of the fibers of the non-woven cloth are exposed from the polymer.

An advantage of the method according to the present invention is that the properties, content, particle content and modulus of the polymer can be adjusted in order to control the hardness and compressibility of the polishing pad.

Another advantage of the method according to the present invention is that the fibers of the non-woven cloth and the holes of the continuous porous polymer enable slurry to flow smoothly.

Another advantage of the method according to the present invention is that where the fibers are made of more than two materials, the rigidity of the polishing pad can be adjusted through adjusting the rigidity and hydrophilicity of the fibers. The rigidity and hydrophilicity of the fibers can be adjusted through adjusting the content of the fibers.

An advantage of the method according to the present invention is that debris is expelled by the fibers exposed from the polymer resin. Thus, the workpiece is not vulnerable to scratches. This is particularly important in the polishing of electro-optic elements or semiconductors.

An advantage of the method according to the present invention is that the polishing pad can be made in a roll-to-roll manner according to the method of the present invention, i.e., it can be made in a roll suitable for mass production. Thus, with the method of the present invention, differences between batches of polishing pads made according to conventional methods are eliminated. That is, polishing pads made according to the method of the present invention provide similar polishing effects.

Other advantages and novel features of the invention will become more apparent from the following detailed description in conjunction with the drawings.

### BRIEF DESCRIPTION OF DRAWINGS

The present invention will be described through detailed illustration of the preferred embodiment referring to the drawings.

FIG. 1 is a flowchart of a method for manufacturing a polishing pad according to the preferred embodiment of the present invention.

FIG. 2 is a side view of a polishing device equipped with a polishing pad manufactured according to the method shown in FIG. 1.

### DETAILED DESCRIPTION OF PREFERRED EMBODIMENT

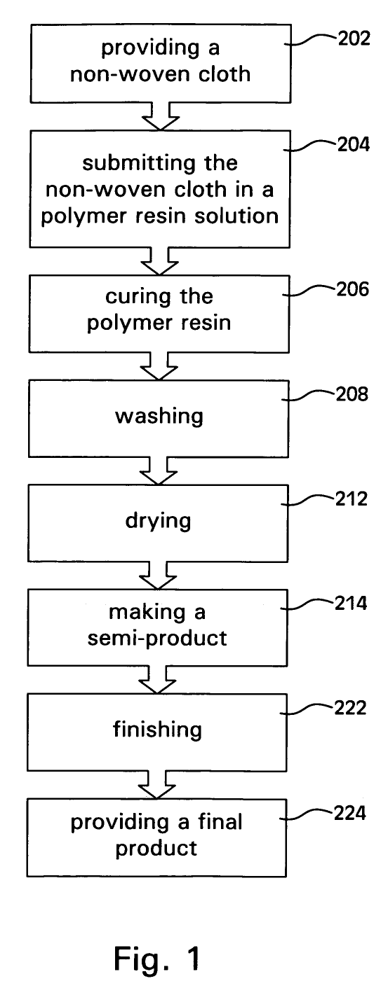

Referring to FIG. 1, there is shown a method for manufacturing a polishing pad according to the preferred embodiment of the present invention.

At step 202, a non-woven cloth is provided. The non-woven cloth is made of a plurality of fibers by stitching. The fibers may be single-component fibers or composite fibers. The single-component fibers may be made of polyamide resin, polyester resin, poly-acrylic resin or polyacrylonitrile resin. The composite fibers may be made of any combination of polyamide resin, polyester resin, poly-acrylic resin or polyacrylonitrile resin. In the preferred embodiment, the non-woven cloth is made of composite fibers of 3 denier by needle punch. The composite fibers include 70% of nylon and 30% of polyethylene terepthalate (“PET”). The thickness of the non-woven cloth is 2.25 mm, the density is 0.22 g/cm³, and the length-specific weight is 496 g/m².

As step 204, the non-woven cloth is submerged in a polymer resin solution. Thus, the polymer resin solution covers the fibers of the non-woven cloth and enters gaps between the fibers of the non-woven cloth. The polymer contains at least one material selected from a group consisting of polyamide resin, polycarbonate resin, epoxy resin, phenolic resin, polyurethane resin, divinylbenzene resin, acrylic acid resin, and polyurethane resin. In the preferred embodiment, the polymer resin solution includes 50% of polyurethane resin, 49% of dimethylformamide (“DMF”), and 1% of surfactant.

At step 206, after soaking in the polymer resin solution, the non-woven cloth is put in a curing agent. The curing agent includes 75% of water and 25% of dimethylformamide (“DMF”). Thus, the polymer resin solution is cured so as to provide a coating of polymer resin. That is, the polymer resin over the fibers of the non-woven cloth and between the fibers of the non-woven cloth is cured. Thus, a continuous porous layer of the polymer resin is bonded to the non-woven cloth.

At step 208, the non-woven cloth and the continuous porous layer of the polymer resin are washed in hot water at 80 degrees centigrade in order wash impurities, residual DMF and residual surfactant from the non-woven cloth.

At step 212, the non-woven cloth and the continuous porous layer of the polymer resin are dried at 140 degrees centigrade.

At step 214, after the non-woven cloth and the continuous porous layer of the polymer resin are dried, a semi-product of the polishing pad is made. The continuous porous layer of the polymer includes a plurality of holes defined therein. If the diameters of the holes are too large, polishing particles in slurry will gather in the holes while polishing a workpiece. If the diameters of the holes are too small, the polishing particles in the slurry will not pass through the holes. Therefore, it is preferred that the diameters of the holes be between 0.1 μm and 500 μm

At step 222, a polishing machine is used to finish the semi-product of the polishing pad. The polishing machine is driven by a current of 28 ampere. In the polishing machine, a piece of sandpaper of □150 and □400 is used and rotated at 1200 rpm and 1300 rpm in order to polish the semi-product of the polishing pad.

At step 224, after finished by the polishing machine, there is obtained a final product of the polishing pad with a thickness of 1.28 mm and a planar surface. On a surface of the final product of the polishing pad, some of the fibers of the non-woven cloth are exposed from the continuous porous polymer resin.

The properties, content, particle content and modulus of the polymer can be adjusted in order to control the hardness and compressibility of the polishing pad. Because the non-woven cloth is submerged in the polymer resin solution and polished, the polishing pad is smooth. Thus, a workpiece can be polished smooth by the polishing pad. Moreover, the workpiece is not vulnerable to the fibers of the non-woven cloth exposed from the polymer resin.

Furthermore, the fibers of the non-woven cloth and the holes of the continuous porous polymer enable the slurry to flow smoothly. The rigidity of the polishing pad can be adjusted through adjusting the rigidity and hydrophilicity of the fibers. The rigidity and hydrophilicity of the fibers can be adjusted through adjusting the content of the fibers. For example, polyethylene terephthalate (“PET”) is hydrophobic while nylon is hydrophilous. Debris is expelled by the fibers exposed from the polymer resin. Thus, the workpiece is not vulnerable to scratches. This is particularly important in the polishing of electro-optic elements or semiconductors.

In addition, the polishing pad can be made in a roll-to-roll manner according to the method of the present invention, i.e., it can be made in a roll suitable for mass production. Thus, with the method of the present invention, differences between batches of polishing pads made according to conventional methods are eliminated. That is, polishing pads made according to the method of the present invention provide similar polishing effects.

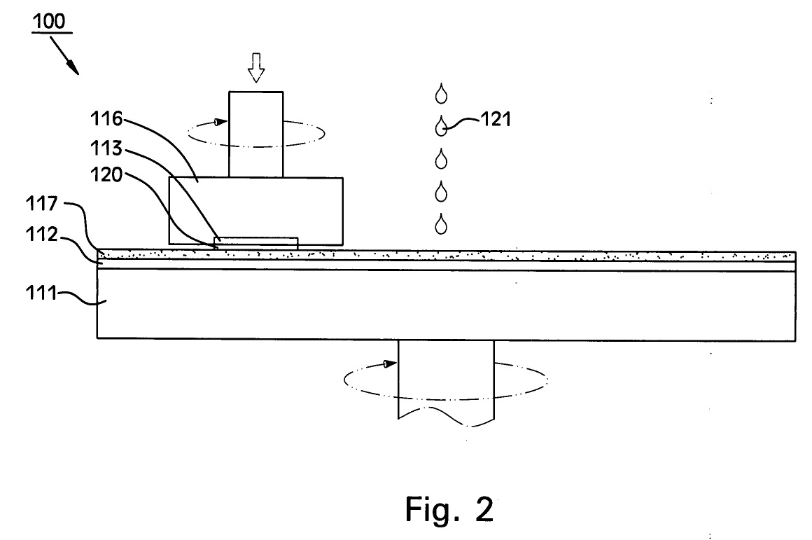

Referring to FIG. 2, a CMP machine 100 includes a lower turntable 111 and an upper turntable 116 to which s sucking device 113 is attached. The CMP machine 100 may be 372M provided by IPEC/Westech. By means glue 112, a polishing pad 117 of the present invention is attached to the lower turntable 111. A workpiece 120 is attached to the upper turntable 116 by the sucking device 113. The workpiece 120 may be a substrate such as an insulating layer of a 6-inch wafer that is made of silica. Slurry 121 is dripped on the polishing pad 117 and carried between the polishing pad 117 and the substrate 120. The slurry 121 may be a solution including 25% of silicon dioxide and 75% of potassium hydroxide with a PH value of 11 such as SS-25™ provided by CABOT. Under a pressure for a period of time, the substrate 120 is polished by the polishing pad 117 as the upper turntable 116 and the lower turntable 111 are driven.

After the substrate 120 is polished, it is tested by an atomic force microscope (“AFM”) in order to obtain the non-uniformity (“NU”) and surface roughness (“RMS”) thereof.

For comparison, an identical substrate is polished by the CMP machine 100 equipped with a conventional polishing pad, IC-1000 provided by Rodel and tested by the AFM.

In Table 1, there is shown the NU of the polishing pad of the present invention compared with that of the conventional polishing pad. In Table 2, there is shown the RMS of the polishing pad of the present invention compared with that of the conventional polishing pad.

TABLE 1

| | IC-1000 | Invention |
|---|---|---|
| NU(non-uniformity) | 4.6% | 1.32% |

The pressure is 5 Psi during the tests.

TABLE 2

| | IC-1000 | Invention |
|---|---|---|
| RMS | 0.335 nm | 0.158 nm |

It is learned from Tables 1 and 2 that a workpiece can be polished better by the polishing pad of the present invention than the conventional polishing pad.

The present invention has been described through the detailed description of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A polishing pad comprising a continuous porous polymer and a non-woven fabric made of fibers, wherein a large portion of the fibers is put in the continuous porous polymer while a small portion of the fibers is exposed from the continuous porous polymer.

2. The polishing pad according to claim 1 wherein the fibers are single fibers.

3. The polishing pad according to claim 2 wherein the single fibers are made from a material selected from a group consisting of polyarmide, polyester, poly-acrylic or polyacrylonitrile.

4. The polishing pad according to claim 1 wherein the fibers are composite fibers.

5. The polishing pad according to claim 4 wherein the composite fibers are made from materials selected from a group consisting of polyamide resin, polyester resin, poly-acrylic resin or polyacrylonitrile resin.

6. The polishing pad according to claim 1 wherein the polymer contains at least one composite selected from a group consisting of polyamide resin, polycarbonate resin, epoxy resin, phenolic resin, polyurethane resin, divinylbenzene resin, acrylic acid resin, and polyurethane resin.

7. The polishing pad according to claim 1 wherein the diameters of the holes are between 0.1 μm and 500 μm.

8. A method for manufacturing a polishing pad, the method comprising the following steps of:
providing a non-woven cloth with a plurality of fibers; and
providing a semi-product of the polishing pad by submerging the non-woven cloth in a polymer resin; and
providing a final product of the polishing pad by finishing the semi-product of the polishing pad.

9. The method according to claim 8 wherein the non-woven cloth is made of the fibers by needle punch.

10. The method according to claim 8 wherein some of the fibers of the non-woven cloth are exposed from the polymer resin at the step of providing a final product of the polishing pad by finishing the semi-product of the polishing pad.

11. The method according to claim 8 wherein the surface of the semi-product of the polishing pad is made planar and smooth at the step of providing a final product of the polishing pad by finishing the semi-product of the polishing pad.

12. The method according to claim 8 wherein the fibers of the non-woven cloth are made of a single material.

13. The method according to claim 12 wherein the material is selected from a group consisting of polyamide resin, polyester resin, poly-acrylic resin or polyacrylonitrile resin.

14. The method according to claim 8 wherein the fibers of the non-woven cloth are made of at least two materials.

15. The method according to claim 14 wherein the materials are selected from a group consisting of polyamide resin, polyester resin, poly-acrylic resin or polyacrylonitrile resin.

16. The method according to claim 8 wherein the polymer contains at least one material selected from a group consisting of polyamide resin, polycarbonate resin, epoxy resin, phenolic resin, polyurethane resin, divinylbenzene resin, acrylic acid resin, and polyurethane resin.

17. The method according to claim 8 wherein the diameters of the holes are between 0.1 μm and 500 μm.
